(19) United States
(12) Patent Application Publication
(10) Pub. No.: US 2019/0370667 A1
(43) Pub. Date: Dec. 5, 2019

(54) LOSSLESS COMPRESSION OF SPARSE ACTIVATION MAPS OF NEURAL NETWORKS

(71) Applicant: Samsung Electronics Co., Ltd., Suwon-si (KR)

(72) Inventor: Georgios GEORGIADIS, Burbank, CA (US)

(21) Appl. No.: 16/046,993

(22) Filed: Jul. 26, 2018

Related U.S. Application Data
(60) Provisional application No. 62/679,545, filed on Jun. 1, 2018.

(51) Int. Cl. G06N 3/10; G06N 3/08; G06N 3/04

(52) U.S. Cl. CPC G06N 3/10; G06N 3/04; G06N 3/08

(57) ABSTRACT

A system and a method provide lossless compression of an activation map of a neural network. The system includes a formatter and an encoder. The formatter formats a tensor corresponding to an activation map into at least one block of values in which the tensor has a size of H×W×C and in which H represents a height of the tensor, W represents a width of the tensor, and C represents a number of channels of the tensor. The encoder encodes the at least one block independently from other blocks of the tensor using at least one lossless compression mode. The at least one lossless compression mode selected to encode the at least one block may different from a lossless compression mode selected to encode another block of the tensor.

### CROSS-REFERENCE TO RELATED APPLICATION

This patent application claims the priority benefit under 35 U.S.C. § 119(e) of U.S. Provisional Patent Application No. 62/679,545, filed on Jun. 1, 2018, the disclosure of which is incorporated herein by reference in its entirety.

### TECHNICAL FIELD

The subject matter disclosed herein generally relates to a system and a method that provides lossless encoding/decoding of activation maps of a neural network to reduce memory requirements, particularly during training of the neural network.

### BACKGROUND

Deep neural networks have recently been dominating a wide range of applications ranging from computer vision (image classification, image segmentation), natural language processing (word-level prediction, speech recognition, and machine translation) to medical imaging, and so on. Dedicated hardware has been designed to run the deep neural networks as efficiently as possible. On the software side, however, some research has focused on minimizing memory and computational requirements of these networks during runtime.

When attempting to train neural networks on embedded devices having limited memory, it is important to minimize the memory requirements of the algorithm as much as possible. During training the majority of the memory is actually occupied by the activation maps. For example, activation maps of current deep neural network systems consume between approximately 60% and 85% of the total memory required for the system. Consequently, reducing the memory footprint associated with activation maps becomes a significant part of reducing the entire memory footprint of a training algorithm.

In a neural network in which a Rectified Linear Unit (ReLU) is used as an activation function, activation maps tend to become sparse. For example, in Inception-V3 model, the majority of activation maps has a sparsity of greater than 50%, and in some cases exceeds 90%. Therefore, there is a strong market need for a compression system that may target this sparsity to reduce the memory requirements of the training algorithm.

### SUMMARY

An example embodiment provides a system to losslessly compress an activation map of a neural network in which the system may include a formatter and encoder. The formatter may format a tensor corresponding to an activation map into at least one block of values in which the tensor has a size of H×W×C in which H represents a height of the tensor, W represents a width of the tensor, and C represents a number of channels of the tensor. The encoder may encode the at least one block independently from other blocks of the tensor using at least one lossless compression mode. In one embodiment, the at least one lossless compression mode may be selected from a group including Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding, and Sparse fixed length encoding. In another embodiment, the at least one lossless compression mode selected to encode the at least one block may be different from a lossless compression mode selected to encode another block of the tensor. In still another embodiment, the encoder may further encode the at least one block by encoding the at least one block independently from other blocks of the tensor using a plurality of the lossless compression modes.

Another example embodiment provides a method to losslessly compress an activation map of a neural network in which the method may include receiving at a formatter at least one activation map configured as a tensor having a tensor size of H×W×C in which H represents a height of the tensor, W represents a width of the tensor, and C represents a number of channels of the tensor; formatting by the formatter the tensor into at least one block of values; and encoding by an encoder the at least one block independently from other blocks of the tensor using at least one lossless compression mode.

Still another example embodiment provides a method to losslessly decompress an activation map of a neural network in which the method may include receiving at a decoder a bitstream representing at least one compressed block of values of the activation map; decompressing by the decoder the at least one compressed block of values to form at least one decompressed block of values in which the decompressed block of values may be independently decompressed from other blocks of the activation map using at least one decompression mode corresponding to at least one lossless compression mode used to compress the at least one block; and deformatting by a deformatter the at least one block into a tensor having a size of H×W×C in which H represents a height of the tensor, W represents a width of the tensor, and C represents a number of channels of the tensor, the tensor being the decompressed activation map.

### BRIEF DESCRIPTION OF THE DRAWINGS

In the following section, the aspects of the subject matter disclosed herein will be described with reference to exemplary embodiments illustrated in the figures, in which:

FIGS. 1A and 1B respectively depict example embodiments of a compressor and a decompressor for encoding/decoding of activation maps of a deep neural network according to the subject matter disclosed herein;

FIGS. 2A and 2B respectively depict example embodiments of an encoding method and a decoding method of activation maps of a deep neural network according to the subject matter disclosed herein; and

FIG. 3 depicts an operational flow of an activation map at a layer of a neural network according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement the teachings of particular embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The subject matter disclosed herein relates to a system and a method that provides lossless encoding/decoding of activation maps of a neural network to reduce memory requirements, particularly during training of a deep neural network. The encoding and decoding steps may be performed on the activation maps for each layer of the neural network independently from activation maps of other layers, and as needed by the training algorithm. While the lossless encoding/decoding technique disclosed herein may compress all degrees of sparsity (including 0% and nearly 100% sparsity), the technique disclosed herein may be optimized if the number of zero values in an activation map is relatively high. That is, the system and method disclosed herein achieves a higher degree of compression for a corresponding higher degree of sparsity. Additionally, the subject matter disclosed herein provides several modifications to existing compression algorithms that may be used to leverage the sparsity of the data of an activation map for a greater degree of compression.

In one embodiment, an encoder that may be configured to receive as an input a tensor of size H×W×C in which H corresponds to the height of the input tensor, W to the width of the input tensor, and C to the number of channels of the input tensor. The received tensor may be formatted into smaller blocks that are referred to herein as “compress units.” Compress units may be independently compressed using a variety of different compression modes. The output generated by the encoder is a compressed bitstream. When a compress unit is decompressed, it is reformatted into its original shape as at least part of a tensor of size H×W×C.

The techniques disclosed herein may be applied to reduce memory requirements for activation maps of neural networks that are configured to provide applications such as, but not limited to, computer vision (image classification, image segmentation), natural language processing (word-level prediction, speech recognition, and machine translation) and medical imaging. The neural network applications may be used within autonomous vehicles, mobile devices, robots, and/or other low-power devices (such as drones). The techniques disclosed herein reduce memory consumption by a neural network during training and/or as embedded in a dedicated device. The techniques disclosed herein may be implemented on a general-purpose processing device or in a dedicated device.

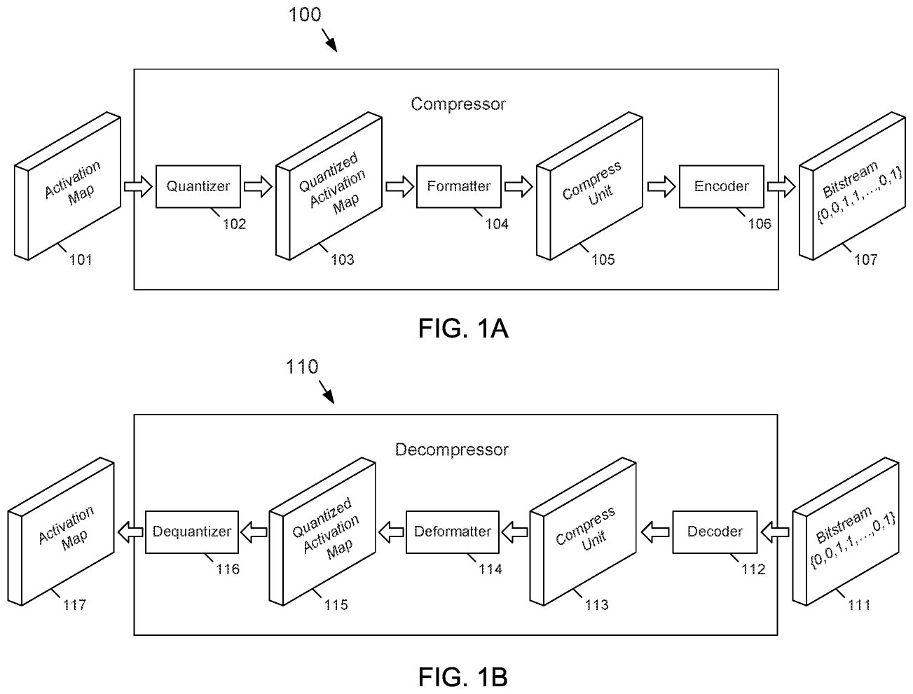

FIGS. 1A and 1B respectively depict example embodiments of a compressor 100 and a decompressor 110 for encoding/decoding of activation maps of a deep neural network according to the subject matter disclosed herein. The various components depicted as forming the compressor 100 and the decompressor 110 may be embodied as modules. The term “module,” as used herein, refers to any combination of software, firmware and/or hardware configured to provide the functionality described herein in connection with a module. The software may be embodied as a software package, code and/or instruction set or instructions, and the term “hardware,” as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-chip (SoC) and so forth.

Prior to compressing an activation map, the compressor 100 and the decompressor 110 are configured to use corresponding compression and decompression modes. The activation map for each layer of the neural network may be processed by the compressor/decompressor pair of FIGS. 1A and 1B to reduce the memory requirements of the neural network during training.

Referring to FIG. 1A, an activation map 101 that has been generated at a layer of a neural network is configured to be a tensor of size H×W×C in which H corresponds to the height of the input tensor, W to the width of the input tensor, and C to the number of channels of the input tensor. That is, an activation map at a layer of a neural network is stored as a single tensor of size H×W×C. If the values of the activation map 101 have not been quantized from floating-point numbers to be integers, the non-quantized values of the activation map 101 may be quantized by a quantizer 102 into integer values having any bit width (i.e., 8 bits, 12 bits, 16 bits, etc.) to form a quantized activation map 103. Quantizing by the quantizer 102, if needed, may also be considered to be a way to introduce additional compression, but at the expense of accuracy.

To facilitate compression, the H×W×C quantized activation map 103 may be formatted by a formatter 104 into blocks of values, in which each block is referred to herein as “compress units” 105. That is, an activation map 103 of tensor size H×W×C may be divided into smaller compress units. The compress units 105 may include K elements (or values) in a channel-major order in which K>0; a scanline (i.e., each block may be a row of an activation map); or K elements (or values) in a row-major order in which K>0. Other techniques or approaches for forming compress units 105 are also possible. For example, a loading pattern of activation maps for the corresponding neural-network hardware may be used as a basis for a block formatting technique.

Each compress unit 105 may be losslessly encoded, or compressed, independently from other compress units by an encoder 106 to form a bitstream 107. Each compress unit 105 may be losslessly encoded, or compressed, using any of a number of compression techniques, referred to herein as “compression modes” or simply “modes.” Example lossless compression modes include, but are not limited to, Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding and Sparse fixed length encoding. It should be understood that other lossless encoding techniques may be used either in addition or as an alternative one of the example compression modes. It should also be noted that many of the example compression modes are publically available or based on publically available compression modes, except, however, the Sparse-Exponential-Golomb and the Sparse-Exponential-Golomb-RemoveMin compression modes. Details for the Sparse-Exponential-Golomb and the Sparse-Exponential-Golomb-RemoveMin compression modes are provided herein.

The Exponential-Golomb encoding is a well-known compression mode that assigns variable length codes in which smaller numbers are assigned shorter codes. The number of bits used to encode numbers increases exponentially, and one parameter, commonly referred to as the order k parameter, controls the rate at which the number of bits increases. The pseudocode below provides example details of the Exponential-Golomb compression mode.

Let x, x>=0 be the input, let k be the parameter (order)

Generate output bitstream: <Quotient Code><Remainder Code>:

Quotient Code:
Encode q=floor (x/2\hat{ }k) using 0-order exp-Golomb code:
z=binary (q+1)
numBits=len (z)
Write numBits−1 zero bits followed by z, and denote by u

Remainder Code:
Encode r=x % 2\hat{ }k in binary, and denote by f=binary (r)

Concatenate u,f to produce output bitstream

An example of the Exponential-Golomb compression mode is:
x=23, k=3
q=floor (23/2\hat{ }3)=2
z=binary (2+1)=binary (3)=11
numBits=len (z)=2
u=011 (2−1=1 zeros followed by z)
f=binary (r)=binary (23% 8)=binary (7)=111
Final output=011+111=011111

Table 1 sets forth values of the Exponential-Golomb compression mode for input values x=0-29 and for order k=0-3.

TABLE 1

| x | k = 0 | k = 1 | k = 2 | k = 3 |
|---|---|---|---|---|
| 0 | 1 | 10 | 100 | 1000 |
| 1 | 010 | 11 | 101 | 1001 |
| 2 | 011 | 0100 | 110 | 1010 |
| 3 | 00100 | 0101 | 111 | 1011 |
| 4 | 00101 | 0110 | 01000 | 1100 |
| 5 | 00110 | 0111 | 01001 | 1101 |
| 6 | 00111 | 001000 | 01010 | 1110 |
| 7 | 0001000 | 001001 | 010110 | 1111 |
| 8 | 0001001 | 001010 | 01100 | 010000 |
| 9 | 0001010 | 001011 | 01101 | 010001 |
| 10 | 0001011 | 001100 | 01110 | 010010 |
| 11 | 0001100 | 001101 | 01111 | 010011 |
| 12 | 0001101 | 001110 | 0010000 | 010100 |
| 13 | 0001110 | 001111 | 0010001 | 010101 |
| 14 | 0001111 | 00010000 | 0010010 | 010110 |
| 15 | 000010000 | 00010001 | 0010011 | 010111 |
| 16 | 000010001 | 00010010 | 0010100 | 011000 |
| 17 | 000010010 | 00010011 | 0010101 | 011001 |
| 18 | 000010011 | 00010100 | 0010110 | 011010 |
| 19 | 000010100 | 00010101 | 0010111 | 011011 |
| 20 | 000010101 | 00010110 | 0011000 | 011100 |
| 21 | 000010110 | 00010111 | 0011001 | 011101 |
| 22 | 000010111 | 00011000 | 0011010 | 011110 |
| 23 | 000011000 | 00011001 | 0011011 | 011111 |
| 24 | 000011001 | 00011010 | 0011100 | 00100000 |
| 25 | 000011010 | 00011011 | 0011101 | 00100001 |
| 26 | 000011011 | 00011100 | 0011110 | 00100010 |
| 27 | 000011100 | 00011101 | 0011111 | 00100011 |
| 28 | 000011101 | 00011110 | 000100000 | 00100100 |
| 29 | 000011110 | 00011111 | 000100001 | 00100101 |

The Sparse-Exponential-Golomb compression mode is an extension, or variation, of Exponential-Golomb compression mode in which if the value x that is to be encoded is a 0, the value x is represented by a “1” in the output bitstream. Otherwise, Exponential-Golomb encoding adds a “0” and then encodes the value x−1 using standard Exponential-Golomb. In one embodiment in which block (compress unit) values are eight bits, an order k=4 may provide the best results.

The Sparse-Exponential-Golomb-RemoveMin compression mode is an extension, or variation, to the Sparse-Exponential-Golomb compression mode that uses the following rules: (1) Before values are encoded in a compress unit, the minimum non-zero value is determined, which may be denoted by the variable y. (2) The variable y is then encoded using Exponential-Golomb compression mode. (3) If the value x that is to be encoded is a 0, then it is encoded as a “1,” and (4) otherwise a “0” is added to the bitstream and then x−y is encoded using the Exponential-Golomb compression mode.

The Golomb-Rice compression mode and the Exponent-Mantissa compression mode are well-known compression algorithms. The pseudocode below sets forth example details of the Golomb-Rice compression mode.

Let x, x>=0 be the input and M be the parameter. M is a power of 2.

q=floor (x/M)

r=x % M

Generate output bitstream: <Quotient Code><Remainder Code>:
Quotient Code:
   Write q-length string of 1 bits
   Write a 0 bit
Remainder Code: binary (r) in log₂ (M) bits

An example of the Golomb-Rice compression mode is:
x=23, M=8, log₂ (M)=3
q=floor (23/8)=2
r=7
Quotient Code: 110
Remainder Code: 111
Output=110111

The Zero-encoding compression mode checks whether the compress unit is formed entirely of zeros and, if so, an empty bitstream is returned. It should be noted that the Zero-compression mode cannot be used if a compress unit contains at least one non-zero value.

The Fixed length encoding compression mode is a baseline, or default, compression mode that performs no compression, and simply encodes the values of a compress unit using a fixed number of bits.

Lastly, the sparse fixed length encoding compression mode is the same as Fixed length encoding compression mode, except if a value x that is to be encoded is a 0, then it is encoded as a 1, otherwise, a 0 is added and a fixed number of bits are used to encode the non-zero value.

Referring back to FIG. 1A, the encoder 106 starts the compressed bitstream 107 with 48 bits in which 16 bits are used respectively denote H, W and C of the input tensor. Each compress unit 105 is compressed iteratively for each compression mode that may be available. The compression modes available for each compress unit may be fixed during compression of an activation map. In one embodiment, the full range of available compression modes may be represented by L bits. If, for example, four compression modes are available, a two bit prefix may be used to indicate corresponding indices (i.e., 00, 01, 10 and 11) for the four available compression modes. In an alternative embodiment, a prefix variable length coding technique may be used to save some bits. For example, the index of the compression mode most commonly used by the encoder 106 may be represented by a “0”, and the second, third and fourth most commonly used compression mode respectively represented by a “10,” “110” and “111.” If only one compression mode is used, then appending an index to the beginning of a bitstream for a compress unit would be unnecessary.

In one embodiment, when a compress unit is compressed, all available compression modes may be run and the compression mode that has generated the shortest bitstream may be selected. The corresponding index for the selected compression mode may be appended as a prefix to the beginning of the bitstream for the particular compress unit and then the resulting bitstream for the compress unit may be added to the bitstream for the entire activation map. The process may then be repeated for all compress units for the activation map. Each respective compress unit of an activation map may be compressed using a compression mode that is different from the compression mode used for an adjacent, or neighboring, compress unit. In one embodiment, a small number of compression modes, such as two compression modes, may be available to reduce the complexity of compressing the activation maps.

In FIG. 1B, the decompressor 110 reads the first 48 bits to retrieve H, W and C, and processes the bitstream 107 one compress unit at a time. The decompressor 110 has knowledge of both L (the number of bits for the index of the mode) and of the number of elements in a compress unit (either W or K depending on the compression mode used). That is, the bitstream 107 corresponding to the original activation map 101 is decompressed by a decoder 112 to form a compress unit 113. The compress unit 113 is deformatted by a deformatter 114 to form a quantized activation map 115 having a tensor of size H×W×C. The quantized activation map 115 may dequantized by a dequantizer 116 to form the original activation map 117.

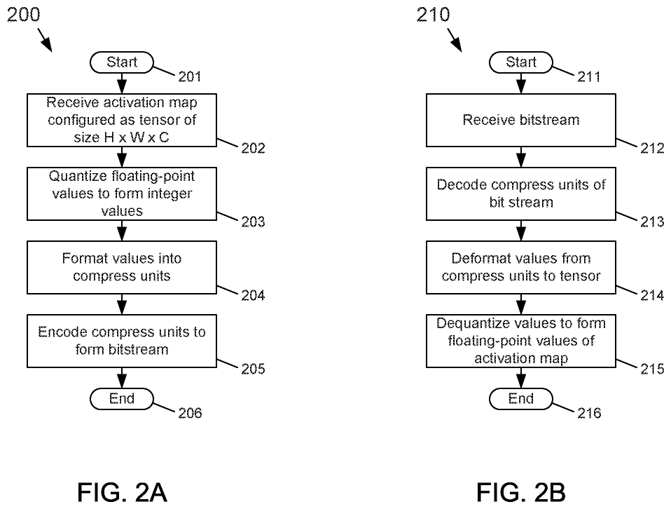

FIGS. 2A and 2B respectively depict example embodiments of an encoding method 200 and a decoding method 210 of activation maps of a deep neural network according to the subject matter disclosed herein. The activation map for each layer of the neural network may be processed by the encoding/decoding method pair of FIGS. 2A and 2B. Prior to compressing an activation map, the compressor 100 and the decompressor 110, such as depicted in FIGS. 1A and 1B, are configured to use corresponding compression and decompression modes.

In FIG. 2A, the process starts at 201. At 202, an activation map is received to be encoded. The activation map has been generated at a layer of a neural network is configured to be a tensor of size H×W×C in which H corresponds to the height of the input tensor, W to the width of the input tensor, and C to the number of channels of the input tensor. If the values of the activation map have not been quantized from floating-point numbers to be integers, then at 202 the non-quantized values of the activation map may be quantized into integer values having any bit width to form a quantized activation map.

At 204, the quantized activation map may be formatted into compress units. At 205, each compress unit may be losslessly encoded, or compressed, independently from other compress units to form a bitstream. Each compress unit may be losslessly encoded, or compressed, using any of a number of compression modes. Example lossless compression modes include, but are not limited to, Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding and Sparse fixed length encoding. Each compress unit 105 is compressed iteratively for each compression mode that may be available. In one embodiment, when a compress unit is compressed, all available compression modes may be run and the compression mode that has generated the shortest bitstream may be selected. When all compress units for the activation map have been encoded, the process ends the activation map at 206.

In FIG. 2B, the process begins at 211. At 212, a bitstream is received and the first 48 bits are read to retrieve an encoded compress unit. At 213, each encoded compress unit is decoded to form a decoded compress unit. At 214, each decoded compress unit is deformatted to form an activation map. If the values of the activation map are to be dequantized, then at 215 the values are dequantized to form a dequantized activation map. The process ends for the activation map at 216.

The following example pseudocode corresponds to the method 200.

```
#Tensor T has size HxWxC
def compress (T):
  bitstream = “”
  for each channel, c, in C
```

CU = formatMaps(c)
for each cu in CU

bitstream + = compressCU(cu)

return bitstream
def compressCU(cu)

bitstreams =

generateBitstreamsforAllComprModes(cu)

minBitstreamIdx, minBitstream =

shortestBitstream(bitstreams)

mode = binary(minBitstreammIdx)
bitstream = mode + minBitstream
return bitstream

}

The following example pseudocode corresponds to the method 200.

def decompress(bitstream):

H,W,C = getActivationMapShape(bitstream[0:48])
bitstream = bitstream[48:]
CU = [ ]
while bitstream 1 = “”:

cu , bitstream = decompressCU(bitstream)
CU.append(cu)

return deformatCU (CU, H, W, C)

#decompressUnit already knows how many compression modes are used
and how many bits are used as header to indicate index of compression
mode. In one embodiment, the number of compression modes used is the
number L.
#decompressUnit also knows how many elements are contained in a
compress unit, in this example the number of elements is K.
#decodeNextValue( bitstream , modeIdx ) uses the modeIdx to choose the
correct decoder to decode the next value. It also strips the bits used from
bitstream. It returns the decoded value and the stripped bitstream.

def decompressCU (bitstream):

modeIdx=getComprModeIndex(bitstream[0:L])
bitstream=bitstream[L:]
cu = [ ]
for k in range (K):

val, bitstream = decodeNextValue (bitstream , modeIdx)
cu.append (val)

return cu , bitstream

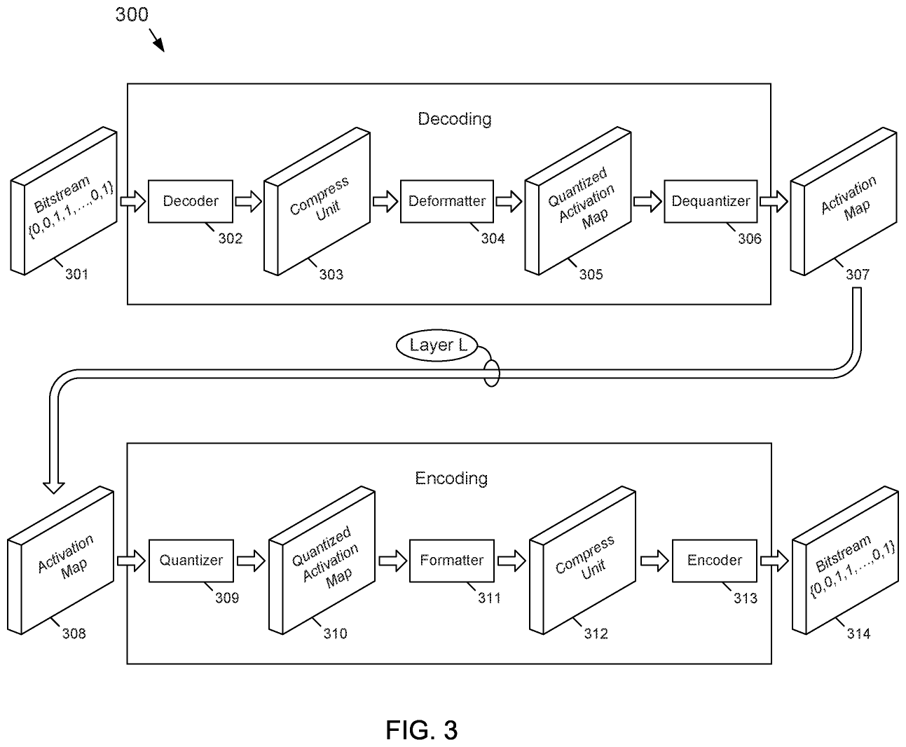

FIG. 3 depicts an operational flow 300 of an activation map at a layer L of a neural network according to the subject matter disclosed herein. The operational flow 300 represents both forward and backward processing directions through the layer L. That is, the operational flow 300 represents an operational flow for training a neural network and for forming an inference from an input to the neural network. An encoded (compressed) representation of an activation map (not shown) is turned into a bitstream 301 as it is read out of a memory (not shown). At 302, the bitstream is decoded to form compress units 303. The compress units 303 are deformatted at 304 to form a quantized activation map 305. (Again, it should be noted that quantizing of an activation map may be optional.) At 306, the quantized activation map 305 is dequantized to form the activation map 307 for the layer L.

The activation map 307 is used at layer L of the neural network to compute an output activation map 308. The output activation map 308 is (optionally) quantized at 309 to form a quantized activation map 310. The quantized activation map 310 is formatted at 311 to form compress units 312. The compress units 312 are encoded at 313 to form a bitstream 314, which is stored a memory (not shown) for later use.

To provide a general sense of the compression potential associated with each of the lossless compression modes indicated herein, an example dataset of activation maps was formed by running ten input images on the Inception-V3 model using the Imagenet database. Activation maps for all layers of the Inception-V3 model were generated for form a dataset, referred to herein as dataset S10. Each activation map was compressed independently and averaged for each compression mode to provide a representative compression factor for each compression mode. Table 2 sets forth the representative compression factors for the different compression modes determined for the dataset S10.

TABLE 2

| | | Compression | |
|---|---|---|---|
| Label | Encoding Technique | Factor (S10) | Comments |
| 1 | Fixed Length | 1.0x | No compression |
| 2 | Sparse Fixed Length | 1.59x | |
| 3 | 1 + 2 | 1.65x | 2 modes used |
| 4 | Exponent-Mantissa | 1.37x | |
| 5 | 3 + 4 | 1.70x | 3 modes used |
| 6 | Golomb-Rice | 1.38x | Parameter M = 16 |
| 7 | 5 + 6 | 1.87x | 4 modes used |
| 8 | Exponential-Golomb | 1.36x | Parameter K = 4 |
| 9 | Sparse-Exponential-Golomb | 1.83x | Parameter K = 4 |
| 10 | 9 + 6 + 1 | 1.97x | 3 modes used |
| 11 | 10 + Zero Encoding | 1.98x | 4 modes used |

As can be seen from Table 2, the maximum compression obtained for the dataset S10 was 1.98× by using four compression modes. Also as can be seen in Table 2, different degrees of compression may be obtained by using different compression modes and different combinations of compression modes.

Another example dataset S500 was formed using 500 input images from the Imagenet training set and the Inception-V3 model for different quantization levels. Table 3 sets forth compression factors for different compression modes and combinations of compression modes that were obtained for the dataset S500. The activation maps of each layer were compressed independently and the results were averaged to obtain one compression factor for each of five runs. The loading pattern used was a channel-major loading pattern.

TABLE 3

| Bits | Exp1 | Exp2 | Exp3 | Exp4 | Exp5 |
|---|---|---|---|---|---|
| 16 | 1.8895 | 1.8891 | 1.8870 | 1.8866 | 1.8868 |
| | k = 12 | k = 12 | k = 12 | k = 12 | k = 12 |
| | | | M = 32 | M = 32 | M = 32 |
| 12 | 1.8695 | 1.8684 | 1.8666 | 1.8666 | 1.8668 |
| | k = 8 | k = 8 | k = 8 | k = 8 | k = 8 |
| | | | M = 128 | M = 128 | M = 128 |
| 8 | 1.8491 | 1.9497 | 1.8694 | 1.8648 | 1.8650 |
| | k = 4 | k = 4 | k = 4 | k = 4 | k = 4 |
| | | | M = 32 | M = 16 | M = 16 |
| 6 | 1.8752 | 1.8754 | 1.9079 | 1.9039 | 1.9043 |
| | k = 2 | k = 2 | k = 2 | k = 2 | k = 2 |
| | | | M = 4 | M = 4 | M = 4 |
| 4 | 1.9522 | 1.9448 | 1.9920 | 1.9810 | 1.9822 |
| | k = 0 | k = 0 | k = 1 | k = 1 | k = 1 |
| | | | M = 2 | M = 2 | M = 2 |

In Table 3, Exp1 used the Sparse-Exponential-Golomb compression mode. Exp2 used the Sparse-Exponential-Golomb and the Fixed Length compression modes. Exp3 used the Sparse-Exponential-Golomb and the Golomb-Rice compression modes. Exp4 used the Sparse-Exponential-Golomb, the Fixed Length and the Golomb-Rice compression modes. Exp5 used the Sparse-Exponential-Golomb, the Fixed Length, the Golomb-Rice and the Zero Encoding compression modes.

As will be recognized by those skilled in the art, the innovative concepts described herein can be modified and varied over a wide range of applications. Accordingly, the scope of claimed subject matter should not be limited to any of the specific exemplary teachings discussed above, but is instead defined by the following claims.

What is claimed is:

1. A system to losslessly compress an activation map of a neural network, the system comprising:
a formatter that formats a tensor corresponding to an activation map into at least one block of values, the tensor having a size of H×W×C in which H represents a height of the tensor, W represents a width of the tensor, and C represents a number of channels of the tensor; and
an encoder that encodes the at least one block independently from other blocks of the tensor using at least one lossless compression mode.

2. The system of claim 1, wherein the at least one lossless compression mode is selected from a group including Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding, and Sparse fixed length encoding.

3. The system of claim 2, wherein the at least one lossless compression mode selected to encode the at least one block is different from a lossless compression mode selected to encode another block of the tensor.

4. The system of claim 2, wherein the encoder further encodes the at least one block by encoding the at least one block independently from other blocks of the tensor using a plurality of the lossless compression modes.

5. The system of claim 2, wherein the at least one block comprises 48 bits.

6. The system of claim 1, wherein the encoder outputs the at least one block encoded as a bit stream.

7. The system of claim 6, further comprising:
a decoder that decodes the at least one block independently from other blocks of the tensor using at least one decompression mode corresponding to the at least one compression mode used to compress the at least one block; and
a deformatter that deformats the at least one block into a tensor having the size of H×W×C.

8. The system of claim 1, wherein the activation map includes floating-point values,
the system further comprising a quantizer that quantizes the floating-point values of the activation map to be integer values.

9. A method to losslessly compress an activation map of a neural network, the method comprising:
receiving at a formatter at least one activation map configured as a tensor having a tensor size of H×W×C in which H represents a height of the tensor, W represents a width of the tensor, and C represents a number of channels of the tensor;
formatting by the formatter the tensor into at least one block of values; and
encoding by an encoder the at least one block independently from other blocks of the tensor using at least one lossless compression mode.

10. The method of claim 9, further comprising selecting the at least one lossless compression mode from a group including Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding, and Sparse fixed length encoding.

11. The method of claim 10, wherein the at least one lossless compression mode selected to encode the at least one block is different from a lossless compression mode selected to compress another block of the tensor.

12. The method of claim 10, wherein encoding the at least one block further comprises encoding the at least one block independently from other blocks of the tensor using a plurality of the lossless compression modes.

13. The method of claim 10, wherein the at least one block comprises 48 bits.

14. The method of claim 9, further comprising outputting from the encoder the at least one block encoded as a bit stream.

15. The method of claim 14, further comprising:
decompressing by a decoder the at least one block independently from other blocks of the tensor using at least one decompression mode corresponding to the at least one compression mode used to compress the at least one block; and
deformatting by a deformatter the at least one block into a tensor have the size of H×W×C.

16. The method of claim 9, wherein the activation map includes floating-point values,
the method further comprising quantizing by a quantizer the floating-point values of the activation map to be integer values.

17. A method to losslessly decompress an activation map of a neural network, the method comprising:
receiving at a decoder a bitstream representing at least one compressed block of values of the activation map;
decompressing by the decoder the at least one compressed block of values to form at least one decompressed block of values, the decompressed block of values being independently decompressed from other blocks of the activation map using at least one decompression mode corresponding to at least one lossless compression mode used to compress the at least one block; and
deformatting by a deformatter the at least one block into a tensor having a size of H×W×C in which H represents a height of the tensor, W represents a width of the tensor, and C represents a number of channels of the tensor, the tensor being the decompressed activation map.

18. The method of claim 17, wherein the at least one lossless compression mode is selected from a group including Exponential-Golomb encoding, Sparse-Exponential-Golomb encoding, Sparse-Exponential-Golomb-RemoveMin encoding, Golomb-Rice encoding, Exponent-Mantissa encoding, Zero-encoding, Fixed length encoding, and Sparse fixed length encoding.

19. The method of claim 18, further comprising:
receiving at a formatter at least one activation map configured as a tensor having a tensor size of H×W×C;
formatting by the formatter the tensor of the received at least one activation map into at least one block of values; and
compressing by an encoder the at least one block independently from other blocks of the tensor of the at least one received activation map using the at least one lossless compression mode.

20. The method of claim 19, wherein the at least one lossless compression mode selected to compress the at least one block is different from a lossless compression mode selected to compress another block of the tensor of the received at least one activation map, and
wherein compressing the at least one block further comprises compressing by the encoder the at least one block independently from other blocks of the tensor of the received at least one activation map using a plurality of the lossless compression modes.
